(19) United States
(12) Patent Application Publication
(10) Pub. No.: US 2014/0301185 A1
(43) Pub. Date: Oct. 9, 2014

(54) HANDLING A FAULT IN AN ETHERNET RING NETWORK

(71) Applicants: Jinjun Chen, Beijing (CN); Yongzhong Gui, Beijing (CN)

(72) Inventors: Jinjun Chen, Beijing (CN); Yongzhong Gui, Beijing (CN)

(73) Assignee: Hangzhou H3C Technologies Co., Ltd, Hangzhou (CN)

(21) Appl. No.: 13/985,836

(22) PCT Filed: Apr. 16, 2012
(86) PCT No.: PCT/CN2012/074091

§ 371 Date: Dec. 2, 2013

(30) Foreign Application Priority Data
Apr. 15, 2011 (CN) 20110095948.6

(51) Int. Cl. H04L 12/24

(52) U.S. Cl. CPC H04L 41/0654
USPC 370/225

(57) ABSTRACT

The present disclosure relates to a fault handling method for a communication network that comprises a plurality of intersecting Ethernet rings including at least a first Ethernet ring having a first master node and a first transit node and a second Ethernet ring having a second master node and a second transit node, the first Ethernet ring and the second Ethernet ring intersecting at a first shared link connecting at least a first shared node and a second shared node shared between the first Ethernet ring and the second Ethernet ring, the method comprising a ring-extension process including the second master node joining the first Ethernet ring as a transit node upon determination of a fault in the first shared link, and the second master node sending a RING EXTEND message to notify the second transit node to join the first Ethernet ring as a transit node of the first Ethernet ring.

Metropolitan area networks and enterprise networks are generally constructed as ring networks due to their reliability. However, a fault of any one of the nodes of the ring disrupts the service. Common techniques for implementing a ring network include Resilient Packet Ring (RPR) or Ethernet ring. A ring network based on RPR requires special hardware, and is therefore expensive to implement. The technology of Ethernet ring is comparatively inexpensive, and is becoming more sophisticated, and so there is a trend towards implementing metropolitan area networks and enterprise networks as Ethernet ring networks.

Several layer 2 protocols may be implemented to address the issues of loops, including Rapid Spanning Tree Protocol (RSTP), Per-VLAN Spanning Tree protocol (PVST), Multi Spanning Tree Protocol (MSTP) and Rapid Ring Protection Protocol (RRPP). Amongst these protocols, RSTP, PVST and MSTP are well-developed, and when a fault occurs at a node, the convergence time for handling the fault is of the order of seconds. RRPP is a Ethernet ring specific link-layer protocol, which is capable of responding rapidly to a fault discovered in a communication path between two nodes, and therefore offers a faster convergence speed than RSTP, PVST and MSTP. Since the convergence time of RRPP is independent of the number of nodes in the Ethernet ring, it is suitable for large-scale networks.

These existing techniques have been implemented in simple ring networks with simple ring topologies.

For larger scale networks such as a metropolitan area network, a configuration including a plurality of intersecting rings may be desirable. It is therefore desirable to provide a method for handling a fault in a link in an Ethernet ring network having a plurality of intersecting rings, and a communication system for implementing such a method.

For a more complete understanding of the present disclosure, specific examples will now be explained with reference to the accompanying drawings, in which:

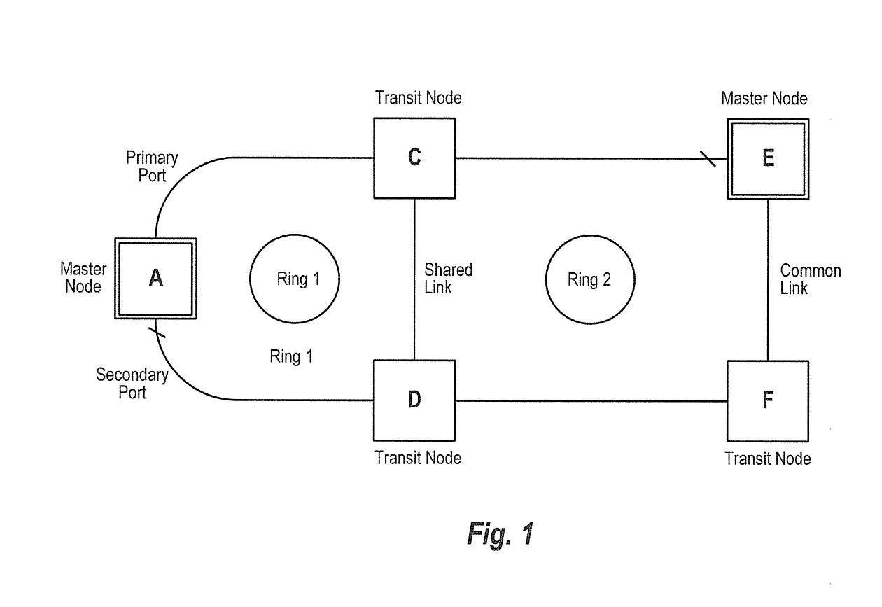

FIG. 1 is the configuration of an example of a multi-ring intersecting Ethernet ring network;

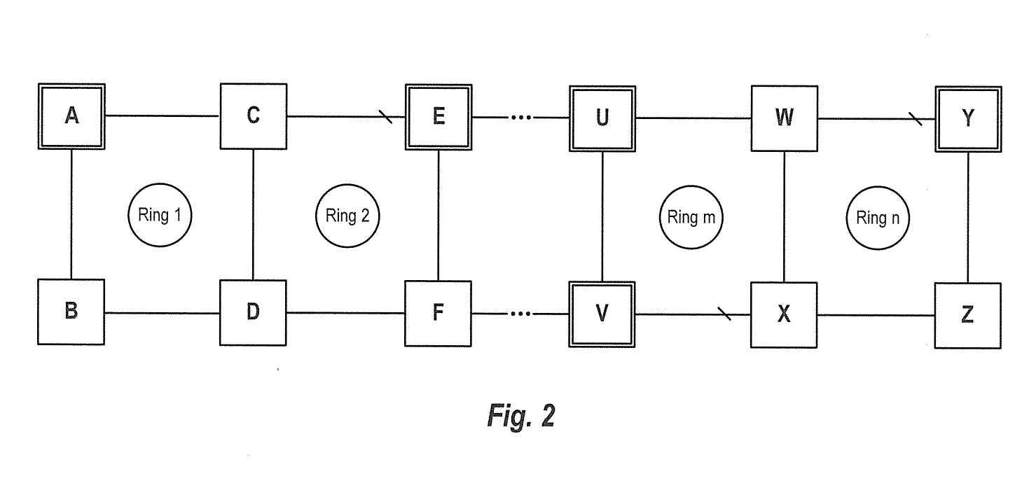

FIG. 2 is the configuration of another example of a multi-ring intersecting Ethernet ring network;

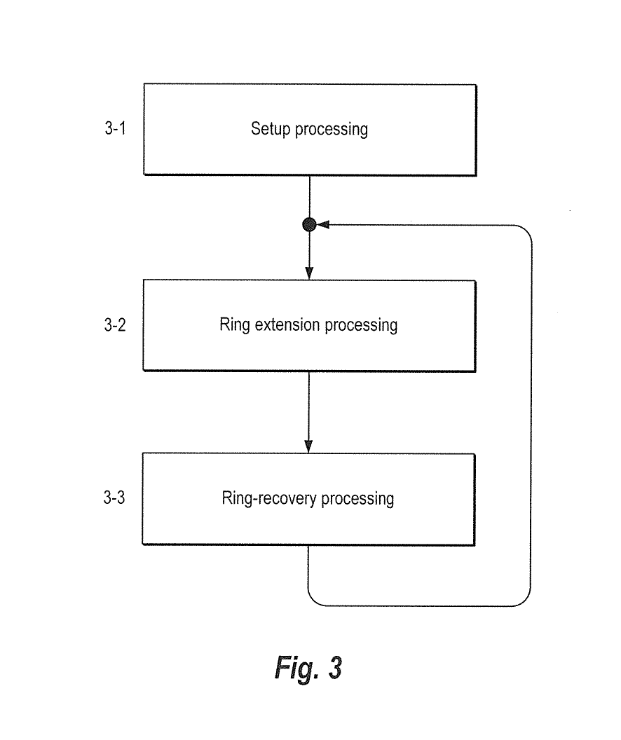

FIG. 3 is a flow chart depicting an example of a method for handling a fault in a link in a multi-ring intersecting Ethernet ring network;

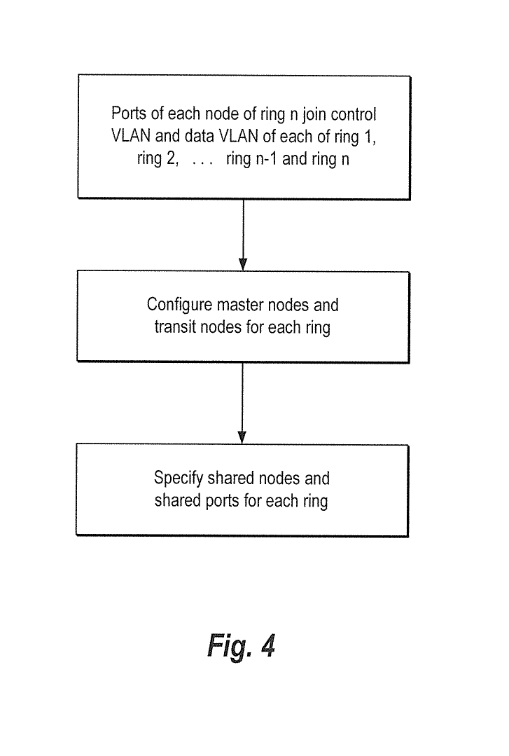

FIG. 4 is a flow chart depicting an example of a setup processing method;

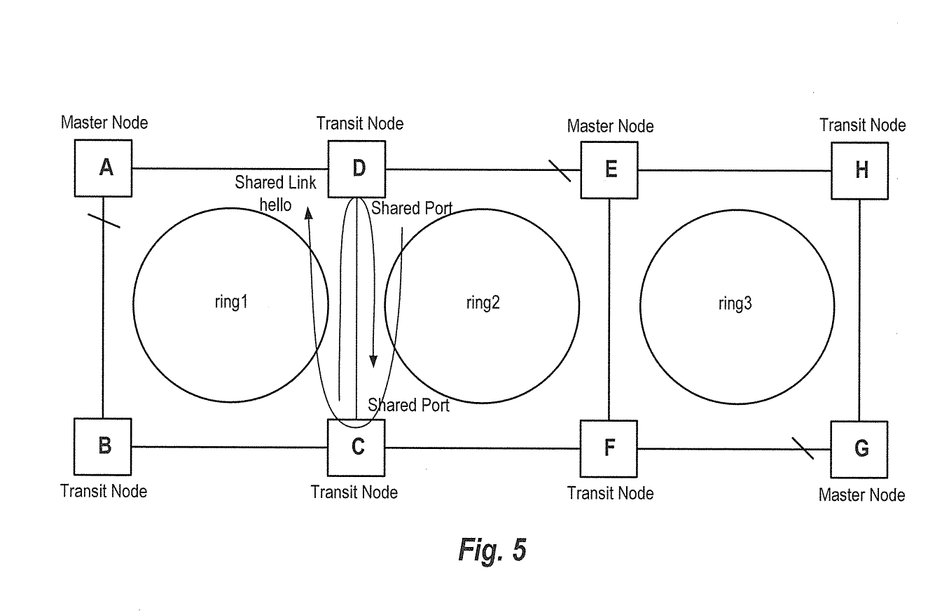

FIG. 5 is the configuration of yet another example of a multi-ring intersecting Ethernet ring network;

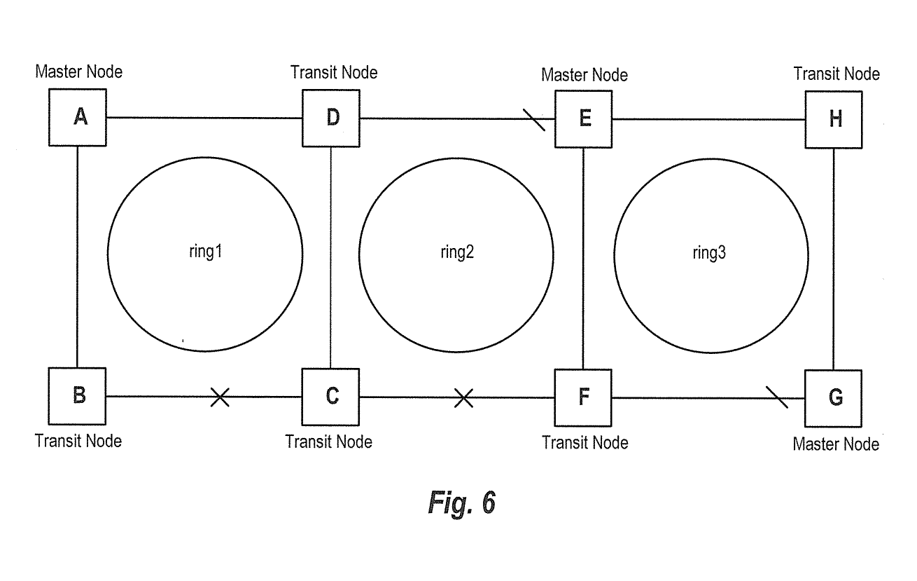

FIG. 6 is the configuration of FIG. 5 depicting a common-link-down state;

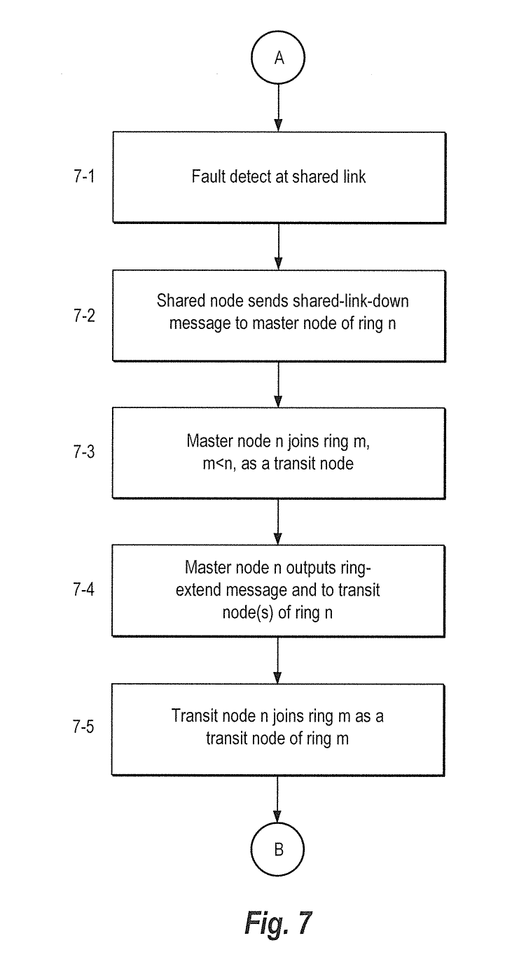

FIG. 7 is a flow chart depicting an example of a ring-extension processing method;

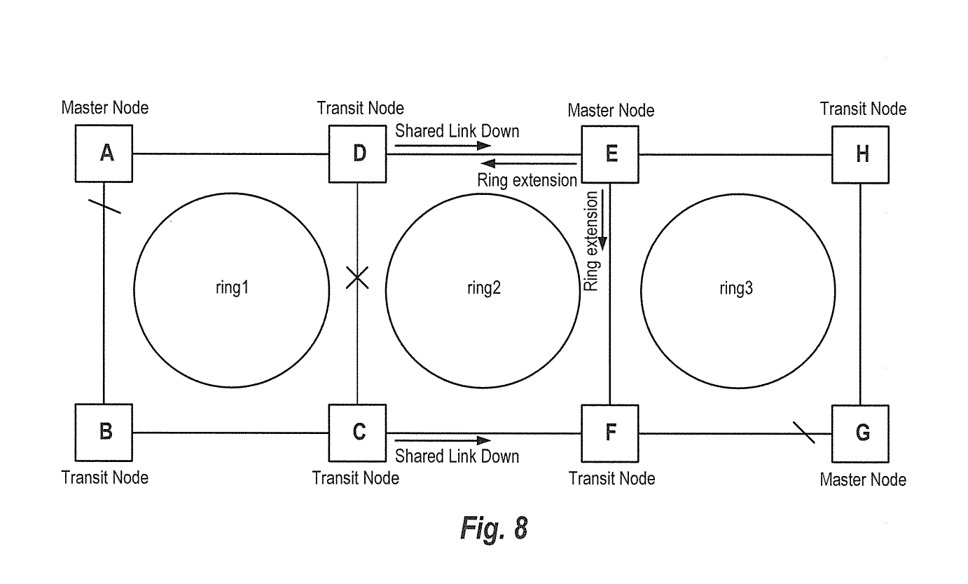

FIG. 8 is the configuration of FIG. 5 depicting a shared-link-down state;

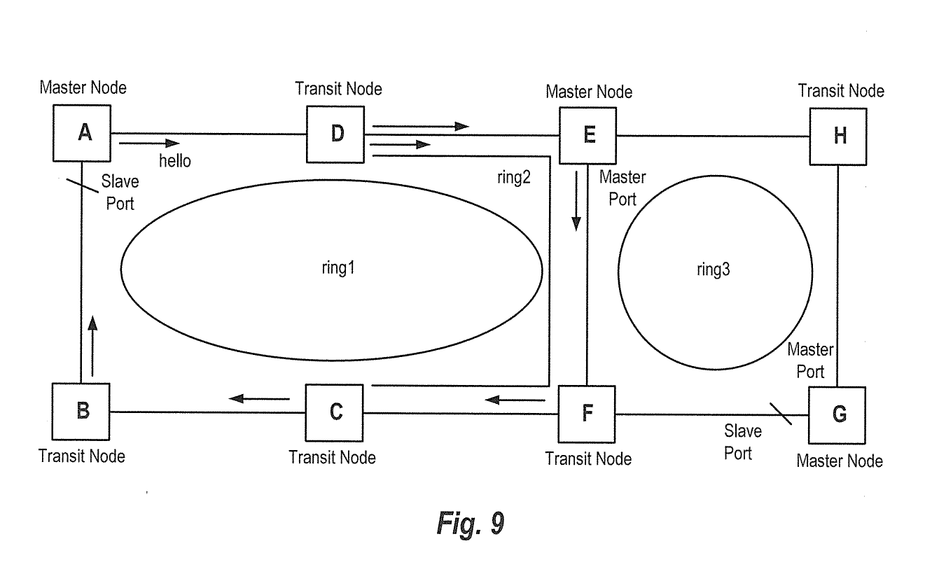

FIG. 9 is the configuration of FIG. 5 depicting ring 1 extending to ring 2;

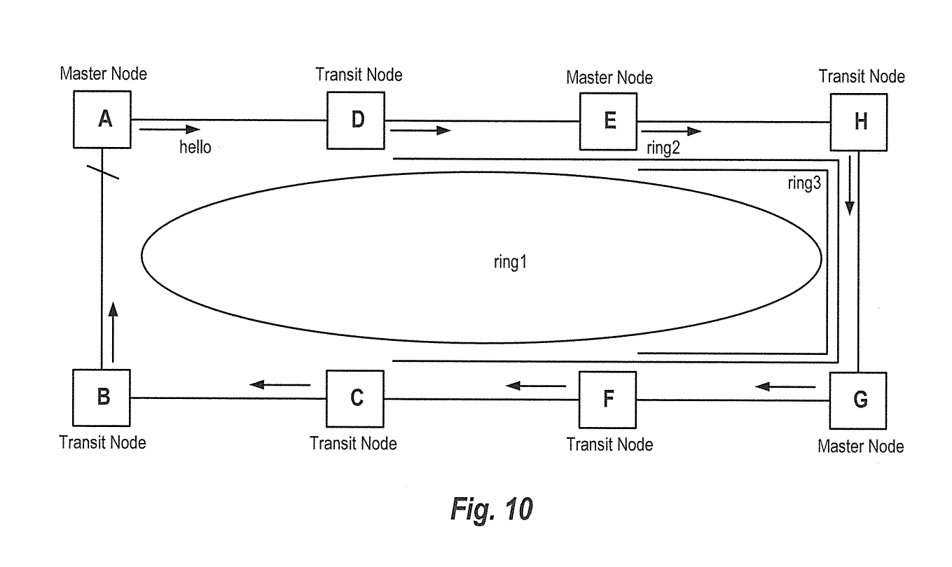

FIG. 10 is the configuration of FIG. 5 depicting ring 1 and ring 2 extending to ring 3;

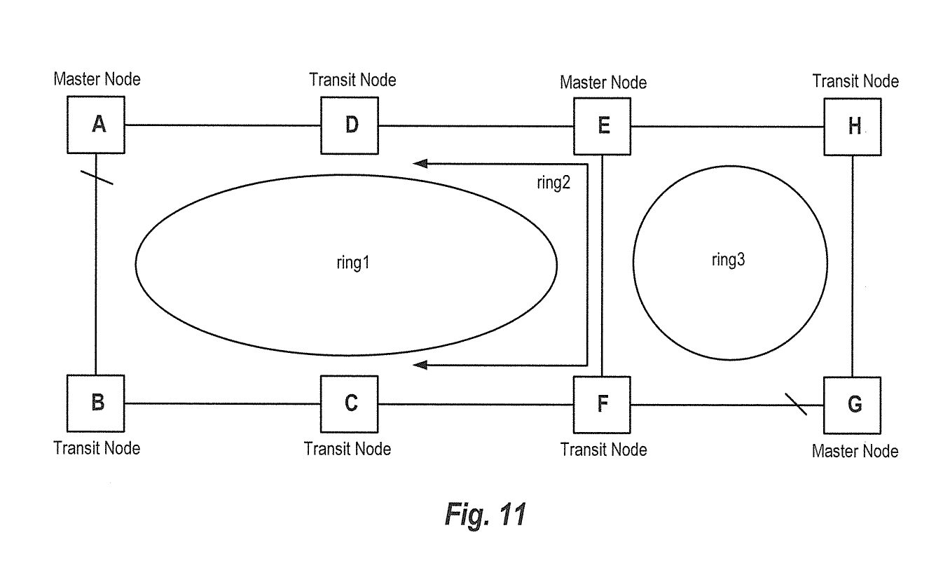

FIG. 11 is the configuration of FIG. 5 depicting the recovery of ring 3;

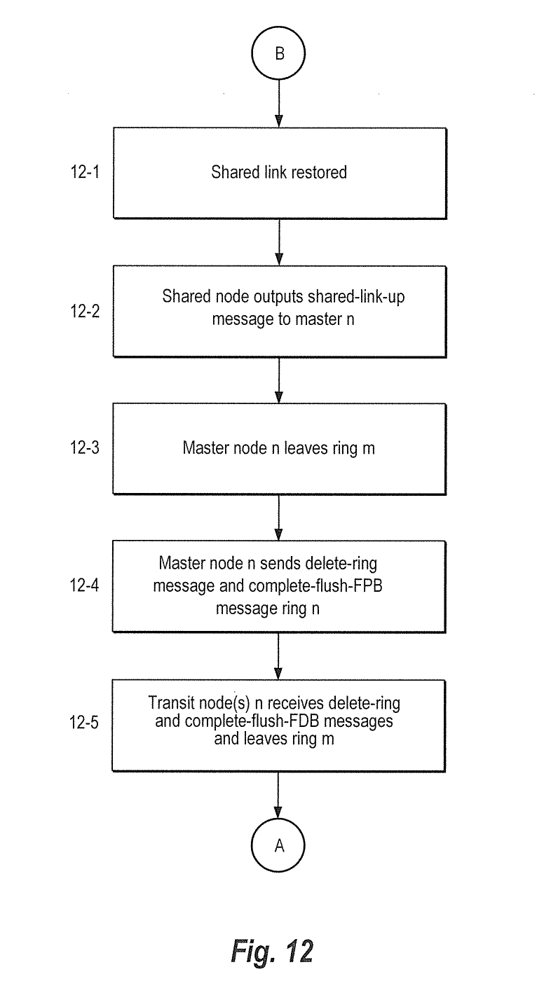

FIG. 12 is a flow chart depicting an example of a ring-recovery processing method;

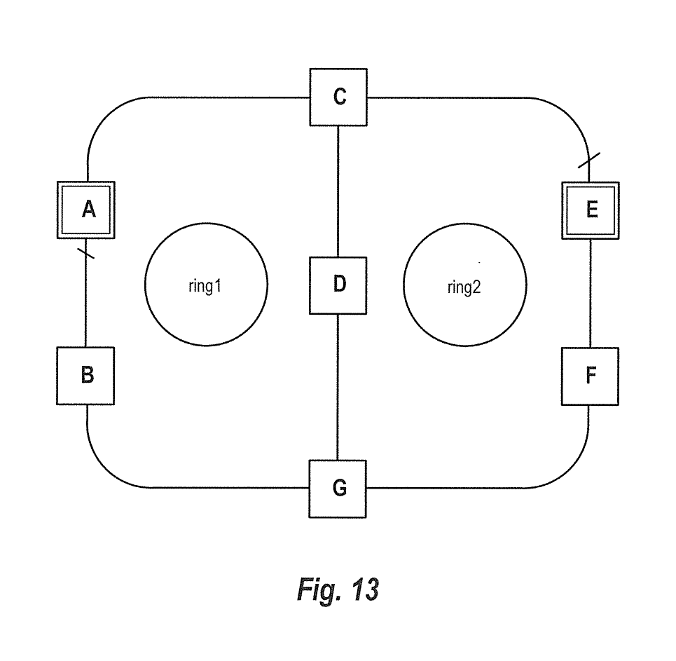

FIG. 13 is the configuration of a further example of a multi-ring intersecting Ethernet ring network;

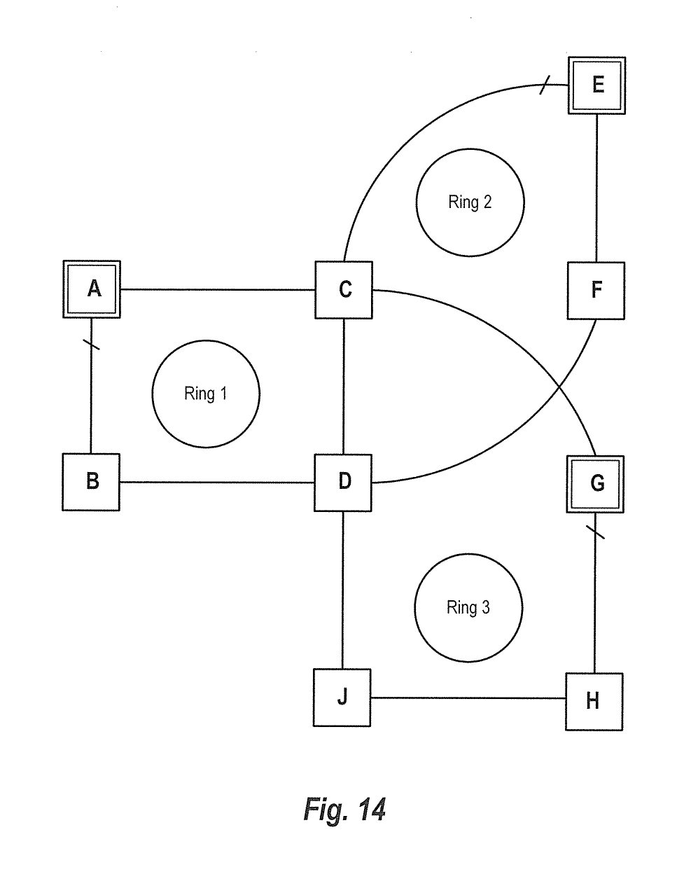

FIG. 14 is the configuration of another further example of a multi-ring intersecting Ethernet ring network; and

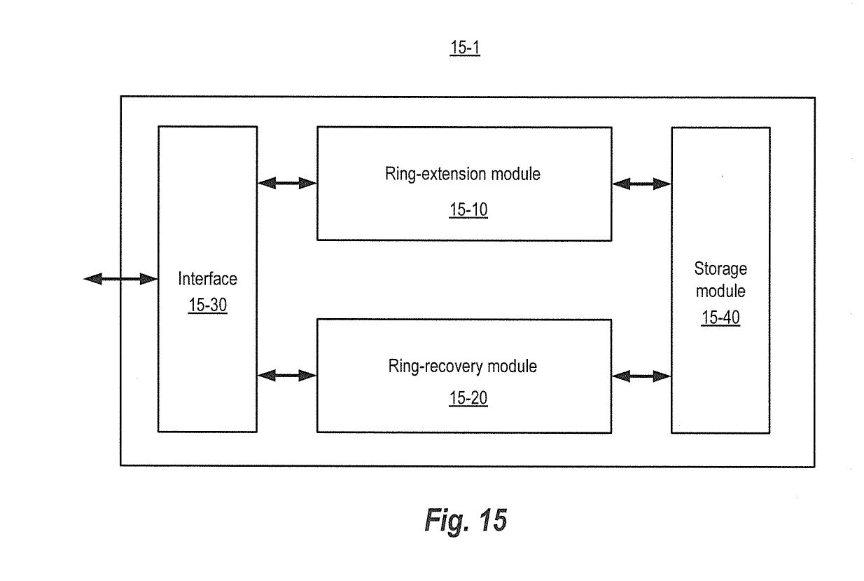

FIG. 15 is a schematic diagram of an example of a communication device.

Embodiments of various aspects of the present disclosure will now be described with reference to the drawings, which are intended only as illustrations of an example. It will be understood that the modules or procedure shown in the figures are not necessarily essential for implementing the present disclosure, and other possibilities will be apparent to a person skilled in the art.

An example of a multi-ring Ethernet ring network is shown in FIG. 1. The Ethernet ring network of the example comprises two Ethernet rings, ring 1 and ring 2, each ring comprising a plurality of nodes. A master node is a node which is the primary control node for the ring, e.g. it may initiate HELLO packets to check the health of the ring and/or perform control to prevent data loops. Each ring is provided with one master node. Nodes other than a master node that are on the same ring as the master node are all transit nodes. In the present example, nodes A and E are respective master nodes for ring 1 and ring 2, and nodes C, D and F are transit nodes.

Nodes C and D are shared nodes. A shared node is a node that is shared between two or more rings (in this example shared between ring 1 and ring 2). A shared link connects nodes C and D and is shared between ring 1 and ring 2. While in this example the shared nodes are both transit nodes, in other examples a master node may be a shared node. Examples of such a configuration will be illustrated and described later on.

Each ring may be identified by a ring ID, or ring sequence number. Here, for illustration purpose, the ring ID for ring 1 will be “1”, the ring ID for ring 2 will be “2”, and the ring ID for ring n will be “n” and so on. Each Ethernet ring forms a respective Virtual Local Area Network (VLAN), which can be identified by a VLAN ID (or network ID). The VLAN of each ring may include a separate control VLAN for communicating control signals and a data VLAN for communicating data signals. In the present example, each ring forms a respective control VLAN and data VLAN, the control VLAN of each ring being identified by a control VLAN ID, and the data VLAN of each ring being identified by a data VLAN ID.

Each node has a plurality of ports for sending or receiving data/control packets. Amongst the plurality of ports of a master node, one port may be specified as a primary port, and one port may be specified as a secondary port. The primary port is configured to transmit a loop detection packet such as a HELLO message, and the secondary port is configured to receive the HELLO message, after it has been forwarded around the ring by the transit nodes of the same ring. During normal operation, when all the links in the Ethernet ring are in a healthy state, or UP state, the secondary port of the master node allows only packets from the control VLAN of the ring to pass, but logically blocks packets from the data VLAN of the ring. When a link in the Ethernet ring is in a broken state, or DOWN state, the master node releases the secondary port and begins to forward packets from the data VLAN. In the example, all ports of the transit nodes are configured to be functionally the same. At a shared link, a port of a shared node which forms a link with a neighbouring ring with a higher ring ID is designated as an extension port, which sends packets to or receives packets from a neighbouring ring.

FIG. 2 shows an example of another configuration of a multi-ring Ethernet ring network. As can be seen in this example, the number of intersecting Ethernet rings is not limited to two, and each ring may have any number of nodes. In this example, nodes A, E, V and Y are the master nodes for rings 1, 2, m and n respectively. Transit nodes C and D are the designated shared nodes shared between rings 1 and 2, and the connection between nodes C and D forms a shared link at which rings 1 and 2 intersect. Master node E and transit node F are the designated shared nodes for ring 2 and a neighbouring ring 3 (not shown), and transit nodes W and X are the designated shared nodes for ring m and the neighbouring ring n.

In an example of a fault handling method for an Ethernet ring network, the method may be considered, for example as shown in FIG. 3, as comprising three processing methods: a setup processing 3-1, a ring-extension processing 3-2, and a ring-recovery processing 3-3.

### Setup Processing

An example of the setup process for an Ethernet ring, such as ring n, is shown in FIG. 4. At block 4-1, each of the plurality of ports of each node belonging to ring n joins the control VLAN and data VLAN of ring n, and also joins the control VLAN and data VLAN of every ring of the interworking Ethernet ring network that has a ring ID lower than n, that is, ring 1 to ring m (m=n−1). The same processing is performed for all remaining Ethernet rings of the communication network, for instance, the ports of each node that belongs to ring m join the control VLAN and data VLAN of ring m and of rings m−1, . . . , 2, 1. The ports of nodes belonging to ring 1 only join the control VLAN and the data VLAN of ring 1. The joining of a port in a VLAN may be implemented by creating a correspondence relationship (or mapping) between the port and the VLAN ID of the VLAN.

At block 4-2, the master node and one or more transit nodes of each ring (e.g. ring n) are configured. As in the examples described above, each ring comprises a master node (e.g. node Y) and one or more transit nodes (e.g. node Z). Each master node is configured to transmit, at regular intervals, a HELLO message from its primary port in the control VLAN of the ring to which the master node belongs, and listen for the HELLO message at its secondary port. The one or more transit nodes of the ring are configured to forward the HELLO message around the ring. When the HELLO message is received at the secondary port this indicates that the ring is in a normal healthy state (the UP state). The master node is configured to block the secondary port from receiving data packets while the ring is in the normal healthy state.

Where two neighbouring rings (e.g. ring m and ring n) intersect, the intersecting link is a shared link. At block 4-3, the nodes on the shared link are specified as shared nodes. In the example of FIG. 2, nodes E and F are specified as shared nodes, and the link between the shared nodes E and F is specified as the shared link between rings 2 and 3 (not shown). Similarly, nodes W and X are specified as shared nodes, and the link between the shared nodes W and X is specified as the shared link between rings m and n. As can be seen, either a master node or a transit node may be configured to function as a shared node. The port of each shared node that connects the respective shared link is specified as a shared port. Each of the two shared nodes transmits SHARED LINK HELLO messages at regular intervals down the shared link from its respective shared port so as to perform a connectivity test on the shared link. For example, FIG. 5 depicts a SHARED LINK HELLO message being transmitted from and returned to shared node C and shared node D. A ‘SHARED LINK HELLO message’ is a HELLO message initiated by a shared node and sent down a shared link. If the shared port of a shared node does not receive a returned SHARED LINK HELLO message within a predetermined time, for instance three times the interval for transmitting a SHARED LINK HELLO message (shared-link-hello interval), the shared port determines that the shared link has lost connectivity and is DOWN.

In certain examples, the format of a HELLO message and the format of a SHARED LINK HELLO message may be the same. For instance, the format of a SHARED LINK HELLO message may be in the form as shown below:

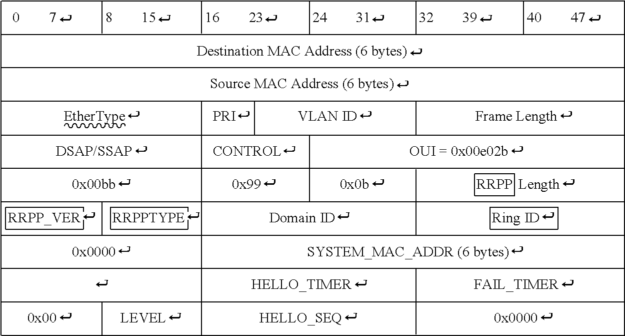

In the message, RRPP_VER is the version number of the RRPP used in the Ethernet ring network. For example, the version number may be 2 to distinguish the version used in the examples herein from a previous version. RRPPTYPE may, for example, be 0x11, to identify the message as a SHARED LINK HELLO message. RRPP Length defines the total length of the RRPP message. Ring ID identifies the ring ID of the Ethernet ring with the highest ring ID amongst the Ethernet rings that share the shared link.

### Ring-Extension Processing

When the master node of an Ethernet ring does not receive a HELLO message within a predetermined time, or a shared node at a shared link does not receive a SHARED LINK HELLO message within a predetermined time, it is determined that the respective link is DOWN, and the status of the ring is determined as FAILED. In the first case where a common link (i.e. a link other than a shared link) is experiencing connectivity issues, the connectivity status is determined as common-link-down, while in the second case where a fault is detected at a shared link, the connectivity status is determined as shared-link-down. According to the present example, the two link-down states are handled differently.

FIG. 6 illustrates the scenario in which a common-link-down is detected by transit nodes B and C. In response, transit nodes B and C transmit LINK DOWN messages in the control VLAN of ring 1. Master node A of ring 1 receives a LINK DOWN message, and releases (unblocks) its secondary port. Master node A then sends COMMON-FLUSH FDB messages in the control VLAN of ring 1 from its secondary port. When the transit nodes B, C and D of ring 1 receive a COMMON-FLUSH FDB message (an instruction to refresh the forwarding table), each of the transit nodes B, C and D renews its own MAC/ARP/ND table entries according to the received COMMON-FLUSH FDB message. When transit nodes C and F detect that the common link CF between nodes C and F is DOWN, the same process may be performed with respect to ring 2, in which master node E releases its secondary port.

In the case of a shared-link-down state, for example as illustrated by FIG. 8 and FIG. 9, the process for handling a share-link-down state is illustrated by the flow diagram of FIG. 7.

At block 7-1, a fault is detected by shared nodes C and D. It is not necessary for both shared nodes C and D to detect the fault simultaneously, and it is possible that only shared node C or only shared node D detects the fault at the shared link.

At block 7-2, shared nodes C and D begin to send SHARED LINK DOWN messages from the respective extension ports at regular intervals (shared-link-down interval) in the control VLAN of ring 2, which, amongst the rings sharing the shared link CD, has the highest ring ID. A SHARED LINK DOWN message contains the ring ID of each ring that will form an extended ring (the ring ID of each ring sharing the shared link CD), and the control VLAN ID and data VLAN ID of each ring forming the extended ring. The RRPPTYPE entry of the SHARED LINK DOWN message may be set to 0x12, to identify the message as a SHARED LINK DOWN message. Shared nodes C and D determine the status of ring 2, that is, the ring that has the highest ring ID amongst the rings sharing the shared link CD, as FAILED.

In the case where the shared node is a master node, for example the shared node E in FIG. 9 which is a master node, the shared node reconfigures its extension port as the primary port, and begins transmitting HELLO messages from the extension port.

Referring to FIG. 8, upon receiving a SHARED LINK DOWN message, transit node F of ring 2 records the number of the port at which the SHARED LINK DOWN message is received (receiving port number), and forwards the SHARED LINK DOWN message to master node E. At this point, transit node F determines the status of ring 2 as FAILED.

Upon receiving the SHARED LINK DOWN message, master node E releases (unblocks) its secondary port, and sends a COMMON-FLUSH FDB message in the control VLAN of ring 2 to instruct each of the nodes in ring 2 to renew its MAC/ARP/ND table entries. At this point, master node E determines the status of ring 2 as FAILED.

At block 7-3, master node E joins ring 1, since ring 1 is a ring that shares the shared link CD and has a ring ID lower than the ring ID of ring 2. Using the ring ID of ring 1 that is contained in the SHARED LINK DOWN message, master node E creates an extended ring that comprises ring 1 and ring 2. Master node E records the correspondence information (or mapping) between the ring ID of each ring of the extended ring, in this case ring 1, and the control VLAN ID and data VLAN ID of its own ring, ring 2. The primary port and the secondary port of master node E join the extended ring by creating and recording the correspondence information between its primary port number and its secondary port number, and the ring ID of each ring of the extended ring, ring 1.

At block 7-4, master node E intermittently sends a RING EXTEND message at regular intervals from its primary port and its secondary port in the control VLAN of ring 2, which contains the ring ID of each ring that shares the shared link CD and has a ring ID lower than the ring ID of ring 2, in this example, ring 1.

An example of a RING EXTEND message is shown below:

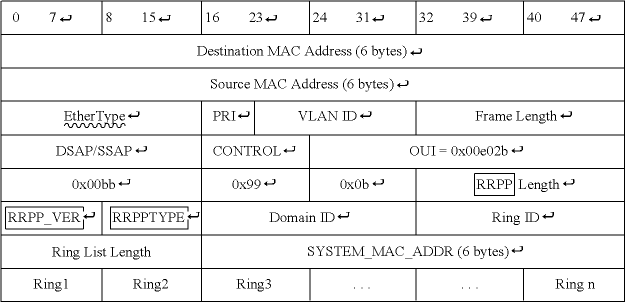

Here, RRPP TYPE may be set as 0x14 to identify the message as a RING EXTEND message. Compared to a SHARED LINK HELLO message, additional entries Ring List Length and a ring list are included. The ring list contains the ring ID of each ring forming the extended ring. The value in the ring list indicates the ID information of one or more rings to be included in the extended ring.

At block 7-5, upon receiving the RING EXTEND message, the transit node(s) of ring 2, node F, forms the extended ring that includes each of the rings indicated in the RING EXTEND message. The transit node of ring 2, node F, is configured such that the port at which the RING EXTEND message is received, and the port at which the SHARED LINK DOWN message is received, join the extended ring. This may be performed by creating and recording correspondence information between the receiving port number of the RING EXTEND message and the receiving port number of the SHARED LINK DOWN message of transit node F, and the ring ID of each of the rings forming the extended ring, for instance ring 1.

Transit node F of ring 2 continues to forward RING EXTEND messages in the control VLAN of ring 2. When the shared nodes C and D receive a RING EXTEND message from master node E, shared nodes C and D stop transmitting SHARED LINK DOWN messages. Thereafter, for each of shared nodes C and D, the shared node is configured such that the receiving port of the RING EXTEND message joins the extended ring specified in the RING EXTEND message. This may be performed by creating and recording correspondence information between the receiving port number of the RING EXTEND message and the ring ID of each of the rings (ring 1) forming the extended ring.

If master node E does not receive a SHARED LINK DOWN message within a predetermined time, for example, 3 times the interval of a SHARED LINK DOWN message, it determines that the ring-extension process is complete, and stops transmitting further RING EXTEND messages.

FIG. 9 shows the configuration of the Ethernet ring network after the method of FIG. 7 as described above has been applied in response to a shared-link-down state detected at the shared link CD. The nodes of ring 2 now function as transit nodes of ring 1, in the same way as transit node B. However, from the perspective of master node A of ring 1 there are no changes to ring 1. Thus, the status of ring 1 is UP, while for ring 2, since shared link CD is DOWN, its status is FAILED. It is therefore possible to realise the extension of an Ethernet ring with a lower ring ID (ring 1) into an Ethernet ring with a higher ring ID (ring 2) without changing the status of the ring with the lower ring ID.

If a shared-link-down state is detected at shared link EF at this point, the method of FIG. 7 may be applied again to extend ring 2 (now part of ring 1) into ring 3. After the extension of ring 1 into ring 2 in response to a shared-link-down state of the shared link CD, the shared link EF now functions as a shared link of ring 1, ring 2 and ring 3. If a shared-link-down state is detected at the shared link EF, as depicted in FIG. 9, the shared nodes E and F send SHARED LINK DOWN messages to the master node of the ring with the highest ring ID at the shared link EF, in this case ring 3. Each SHARED LINK DOWN message contains the ring IDs of ring 1 and ring 2, as well as the respective control VLAN ID and data VLAN ID of ring 1 and ring 2. Blocks 7-3 to 7-5 of the process of FIG. 7 are similarly performed so that ring 1 continues to extend into ring 3, as shown in FIG. 10. The status of ring 1 is UP, while the status of each of ring 2 and ring 3 is now FAILED.

If a common-link-down state is detected at a common link in the extended ring, the same process performed on the Ethernet ring network of FIG. 6 may be performed on the extended ring network.

### Ring-Recovery Processing

Similar to the ring-extension processing, the recovery of a previously down common link or a previously down shared link is handled different by the ring-recovery processing.

While a common link is in a DOWN state, if the master node receives at its secondary port a HELLO message that it has transmitted in the control VLAN of the Ethernet ring to which it belongs, the master node determines that the common link has been restored. For the transit nodes that are connected by the DOWN common link, when the transit nodes detect that the common link is restored, each transit node pre-blocks the port that is on the common link so as to prevent temporary data loops forming in the network. Upon receiving the HELLO message, the master node once again blocks its secondary port, and transmits COMPLETE-FLUSH FDB messages from its primary port in the control VLAN to notify the transit nodes of the same ring to renew their respective MAC/ARP/ND table entries. When each of the transit nodes receives a COMPLETE-FLUSH FDB message, it renews its MAC/ARP/ND table entries, and, if it has pre-blocked a port, releases the pre-blocked port.

FIG. 12 is a flow chart of an example of the ring-recovery processing method for handling the recovery of a shared link of an intersecting Ethernet ring network that is in a shared-link-down state. In the present example, is assumed that the ring IDs of rings 1 to n are respectively 1, 2, 3, . . . , n. For illustration of the ring-recovery processing method, the ring network of FIG. 10 is used in the following as an example only.

At block 12-1, a shared node at a shared link that has been in a DOWN state receives a SHARED LINK HELLO message sent by itself, and determines that the shared link is restored. For example, in FIG. 10, when shared node E or shared node F receives a SHARED LINK HELLO message, it determines that the shared link EF is restored, and that the status of ring 3 changes from FAILED to UP. Shared node E and shared node F each pre-blocks its respective extension port, and withdraws the respective extension port from each ring sharing the shared link EF, which has a ring ID that is not the highest ring ID at the shared link EF. In this example, shared node E and shared node F withdraw their respective extension port from ring 1 and ring 2. Then, each of shared node E and shared node F renews its own MAC/ARP/ND table entries.

Meanwhile, at block 12-2, each shared node transmits SHARED LINK UP messages to the master node of the ring with the highest ring ID at this shared link. In the present example, shared node E and shared node F each transmits SHARED LINK UP messages to master node G of ring 3. A SHARED LINK UP message contains the ring ID of each extended ring, or in other words, each ring sharing the shared link EF with a ring ID lower than the highest ring ID at the shared link EF. Here in this example, a SHARED LINK UP message contains the ring ID of ring 1 and ring 2.

The format of a SHARED LINK UP message is essentially the same as a SHARED LINK HELLO message. The RRPP TYPE value may be set to 0x13, identifying the message as a SHARED LINK UP message. The field Ring ID is set to the ring ID of the Ethernet ring with the highest ring ID amongst the Ethernet rings that share the shared link.

If the shared node in this step is a master node, for instance master node E in this example, shared node E moreover reconfigures its extension port and its shared port so that the shared port becomes the primary port of master node E again, and master node E resumes intermittent transmission of HELLO messages from the reconfigured shared port that is the primary port.

While the shared link is DOWN, if the master node of an Ethernet ring that is sharing the shared link receives, at its secondary port, a HELLO message sent by itself in the control VLAN of the Ethernet ring, or if the master node receives a SHARED LINK UP message sent by a shared node at the shared link, the master node determines that the shared link is restored. In the present example, when master node G receives a HELLO message sent by itself or a SHARED LINK UP message sent by shared node E or shared node F, master node G determines that the shared link EF is restored, and that the status of ring 3 changes from FAILED to UP.

Master node G then, at block 12-3, deletes all information regarding its correspondence with the extended rings, which are Ethernet rings that share the shared link with ring ID lower than the highest ring ID at the shared link—ring 1 and ring 2 in this case, according to the ring ID of the extended rings. In doing so, master node G removes itself from the extended ring 1 and ring 2. Moreover, master node G blocks its secondary port again from receiving signals from the data VLAN.

The information to be deleted here includes the ring ID of each extended ring, ring 1 and ring 2, the mapping relationship (correspondence information) between the ring ID of each extended ring and the respective control VLAN ID and data VLAN ID, and the mapping relationship (correspondence information) between the ring ID of each extended ring and the port number of the or each port of the master node that has joined the respective extended ring.

At block 12-4, in response to determining that the shared link is restored, master node G transmits DELETE RING messages and COMPLETE-FLUSH FDB messages in the control VLAN of ring 3.

A DELETE RING message contains the ring ID of each extended ring. The format of a DELETE RING message is essentially the same as a RING EXTEND message. The RRPP TYPE value may be set to 0x15, identifying the message as a DELETE RING message.

When the transit node(s) of the Ethernet ring that is sharing the DOWN shared link receives, at block 12-5, a COMPLETE-FLUSH FDB message or a DELETE RING message from the master node, for instance, when transit node H receives a COMPLETE-FLUSH FDB message or a DELETE RING message from master node G, the transit node determines that the status of the Ethernet ring changes from FAILED to UP. Upon receiving a COMPLETE-FLUSH FDB message, transit node H renews its MAC/ARP/ND table entries in accordance with the received COMPLETE-FLUSH FDB message. Upon receiving a DELETE RING message, transit node H deletes all information regarding its correspondence with the extended rings according to the ring ID of each extended ring included in the received DELETE RING message. The information to be deleted includes the ring ID of each extended ring included in the DELETE RING message, ring 1 and ring 2, the mapping relationship (correspondence information) between the ring ID of each extended ring and the respective control VLAN ID and data VLAN ID, and the mapping relationship (correspondence information) between the ring ID of each extended ring and the port number of the or each port in transit node H that has joined the respective extended ring. Thus, transit node H withdraws itself from ring 1 and ring 2.

The ring-recovery processing to recover ring 3 and retract ring 1 and ring 2 is complete, as shown in FIG. 11. The status of ring 3 is now changed from FAILED to UP.

In the present example, if the shared link CD is also restored after the shared link EF is restored, the ring-recovery processing as described above with reference to FIG. 12 may be applied to recover ring 2.

Referring to FIG. 11, when the shared link CD is restored, each of the shared nodes at the shared link, shared node C and shared node D, withdraws its extension ports from ring 1 and pre-blocks its extension port to prevent the forming of data loops. Each of shared nodes C and D renews its own MAC/ARP/ND table entries, and, at the same time, transmits SHARED LINK UP messages to master node E of ring 2, each SHARED LINK UP message containing the ring ID of the extended ring, ring 1.

Upon receiving a SHARED LINK UP message, master node E deletes all information regarding its correspondence with ring 1, and transmits COMPLETE-FLUSH FDB messages and DELETE RING messages in the control VLAN of ring 2. The DELETE RING messages contain the ring ID of ring 1. Upon receiving a COMPLETE-FLUSH FDB message, transit node F renews its own MAC/ARP/ND table entries in accordance with the received COMPLETE-FLUSH FDB message. Upon receiving a DELETE RING message, transit node F deletes all information regarding its correspondence with ring 1. Upon receiving a COMPLETE-FLUSH FDB message, shared nodes C and D release their respective extension ports.

Thus, the ring-recovery processing to recover ring 2 and retract ring 1 is complete, and the status of Ethernet rings 1, 2 and 3 are all UP.

It should be noted that the implementation examples of the set-up processing, the ring-extension processing and the ring-recovery processing may be applied to various configurations of Ethernet ring network. For example, one or more of the processing methods may be applied to an Ethernet ring network having a configuration in which a shared link connects more than two shared nodes, such as the configuration illustrated in FIG. 13, or to an Ethernet ring network having a configuration in which the shared nodes of a shared link are shared by more than two Ethernet rings, such as the configuration illustrated in FIG. 14.

FIG. 15 is an example of a network device (such as a switch or router etc), which may be employed as a node in an Ethernet ring network as described above and in particular may be configured to act as a master node. When configured to function as a master node, the network device 15-1 has a primary port and a secondary port, the secondary port being blocked from receiving data. The network device 15-1 comprises a ring-extension module 15-10, a ring-recovery module 15-20 and an interface 15-30. A storage module 15-40 may be further provided if desired, for example, for storing correspondence information.

When the network device 15-1 is deployed in an Ethernet ring that intersects a neighbouring Ethernet ring with a lower ring ID at a shared link, the ring-extension module 15-10 determines that there is a fault in the shared link, for example by receiving a SHARED LINK DOWN message from a shared node at the shared link, and unblocks its secondary port to allow data to be received from the data VLAN of the Ethernet ring. The ring-extension module 15-10 then causes the network device 15-1 to join the neighbouring Ethernet ring, and sends RING EXTEND messages via the interface 15-30 in control VLAN of the Ethernet ring to notify other communication devices of the Ethernet ring to join the neighbouring Ethernet ring.

The ring-recovery module 15-20 determines that the shared link is restored, for example by receiving a SHARED LINK UP message from a shared node at the shared link, and blocks the secondary port again from receiving data from the data VLAN. The ring-recovery module 15-20 then causes the network device 15-1 to leave the neighbouring Ethernet ring, and sends DELETE RING messages in the control VLAN of the Ethernet ring via the interface 15-30 to notify other communication devices of the Ethernet ring to leave the neighbouring Ethernet ring.

Alternatively the network device of FIG. 15 may be configured to function as a transit node for use in an Ethernet ring network. In this case, the ring-extension module 15-10 receives a RING EXTEND message from the control VLAN of the Ethernet ring, and in response causes the network device 15-1 to join the neighbouring Ethernet ring in accordance with the received RING EXTEND message. The ring-recovery module 15-20 receives a DELETE RING message from the control VLAN of the Ethernet ring, and in response causes the communication device to leave the neighbouring Ethernet ring in accordance with the received DELETE RING message.

The ring-extension module 15-10 and the ring-recovery module 15-20 described above may for instance be implemented as software to be executed by a processor or as hardware modules.

The network device of FIG. 15 may be provided at a shared link as a shared node. In this case, a port of the network device 15-1, is configured as an extension port that connects to the Ethernet ring. In addition to the functions described above, the ring-extension module 15-10, or the processing module 16-10, sends SHARED LINK DOWN messages in the control VLAN of the Ethernet ring in response to detecting a fault in the shared link. The ring-recovery module 15-20, or the processing module 16-10, sends SHARED LINK UP messages in the control VLAN of the Ethernet ring in response to detecting that the shared link is restored, and blocks the extension port from sending or receiving data from the data VLAN of the Ethernet ring until the communication device 15-1 or 16-1 receives a COMPLETE-FLUSH FDB message from the master node of the Ethernet ring via the interface 15-30 or 16-20, whereupon said extension port is unblocked.

The present disclosure thus provides a fault handling method for implementation in a communication network, such as an RRPP multiple-ring Ethernet ring network, and a network device, such as a master node, a transit node or a shared node, for deploying in such a communication network, that may provide a protection mechanism that is data-loop free for such a multiple-ring communication network. Moreover, the present disclosure may provide an improved mechanism for monitoring the connectivity for such a multiple-ring communication network. Furthermore, the present disclosure may provide a framework for automatically extending, and subsequently recovering, an RRPP Ethernet ring in such a multiple-ring communication network.

Although the flow diagrams described above show a specific order of execution, the order of execution may differ from that which is depicted. For example, the order of execution of two or more blocks may be interchanged relative to the order shown. Also, two or more blocks shown in succession may be executed concurrently or with partial concurrence. All such variations are within the scope of the present disclosure.

The above examples can be implemented by hardware, software, firmware, or a combination thereof. For example, the various methods, processes and functional modules described herein may be implemented by a processor (the term processor is to be interpreted broadly to include a CPU, processing unit, ASIC, logic unit, or programmable gate array etc.). The processes, methods and functional modules may all be performed by a single processor or divided amongst several processors. The processes, methods and functional modules may be implemented as machine readable instructions executable by one or more processors, hardware logic circuitry of the one or more processors, or a combination thereof. Further, the teachings herein may be implemented in the form of a software product, the computer software product being stored in a storage medium and comprising a plurality of instructions for making a computer device (e.g. a personal computer, a server or a network device such as a router, switch, access point etc.) implement the method recited in the examples of the present disclosure.

It should be understood that embodiments of the method for handling faults in a link of a communication network, and embodiments of the communication device, such as a master node, a transit node and a shared node, given above are implementation examples only, and do not limit the scope of the invention. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A fault handling method for a communication network that comprises a plurality of intersecting Ethernet rings including at least a first Ethernet ring having a first master node and a first transit node and a second Ethernet ring having a second master node and a second transit node, the first Ethernet ring and the second Ethernet ring intersecting at a first shared link connecting at least a first shared node and a second shared node shared between the first Ethernet ring and the second Ethernet ring, the method comprising:
a ring-extension process comprising:
the second master node joining the first Ethernet ring as a transit node upon determination of a fault in the first shared link; and
the second master node sending a RING EXTEND message to notify the second transit node to join the first Ethernet ring as a transit node of the first Ethernet ring.

2. The method of claim 1, wherein
the ring-extension process further comprises:
the first shared node sending a SHARED LINK DOWN message upon detection of the fault in the first shared link, wherein the second master node determines the fault in the first shared link by receiving the SHARED LINK DOWN message.

3. The method of claim 1, wherein the second master node has a primary port and a secondary port, and wherein each of the first and second Ethernet rings are identified by a ring sequence number, the ring sequence number of the first Ethernet ring being lower than the ring sequence number of the second Ethernet ring, and each of the first and second Ethernet rings forming a respective ring network identified by a respective network ID, and wherein
the ring-extension process further comprises:
the first shared node sending a SHARED LINK DOWN message upon detection of the fault in the first shared link, wherein the second master node determines the fault in the first shared link by receiving the SHARED LINK DOWN message, and wherein the second master node joining the first Ethernet ring as a transit node comprises:
the second master node creating first correspondence information between the network ID of the second Ethernet ring and the ring sequence number of the first Ethernet ring contained in the received SHARED LINK DOWN message; and
the second master node creating second correspondence information between the primary port and the secondary port of the second master node and the ring sequence number of the first Ethernet ring contained in the received SHARED LINK DOWN message.

4. The method of claim 1, wherein each of the first and second Ethernet rings is identified by a ring sequence number, the ring sequence number of the first Ethernet ring being lower than the ring sequence number of the second Ethernet ring, and wherein the ring-extension process further comprises:
the first shared node sending a SHARED LINK DOWN message upon detection of the fault in the first shared link, wherein the second master node determines the fault in the first shared link by receiving the SHARED LINK DOWN message;
the second transit node receiving the SHARED LINK DOWN message from the first shared node and the RING EXTEND message from the second master node; and
the second transit node joining the first Ethernet ring as a transit node of the first Ethernet ring upon receiving the RING EXTEND message by creating correspondence information between a port at which the RING EXTEND message is received by the second transit node and a port at which the SHARED LINK DOWN message is received by the second transit node, and the ring sequence number of the first Ethernet ring contained in the received RING EXTEND message and SHARED LINK DOWN message.

5. The method of claim 1, wherein each of the first and second Ethernet rings is identified by a ring sequence number, the ring sequence number of the first Ethernet ring being lower than the ring sequence number of the second Ethernet ring, and wherein
the ring-extension process further comprises:
the first shared node sending a SHARED LINK DOWN message upon detection of the fault in the first shared link, wherein the second master node determines the fault in the first shared link by receiving the SHARED LINK DOWN message;
the first shared node receiving a RING EXTEND message from the second master node and causing the sending of the SHARED LINK DOWN message to stop;
the first shared node creating correspondence information between a port at which the RING EXTEND message is received by the first shared node and the ring sequence number of the first Ethernet ring based on the received RING EXTEND message; and
the second master node causing the sending of a RING EXTEND message to stop when no SHARED LINK DOWN message is received within a predetermined interval.

6. The method of claim 1 further comprising:
a ring-recovery process, including:
the second master node determining that the first shared link is restored and leaving the first Ethernet ring; and
the second master node notifying the second transit node to leave the first Ethernet ring.

7. The method of claim 6, wherein
the ring-recovery process further comprises:
the first shared node receiving a SHARED LINK HELLO message from the first shared link and determining that the first shared link is restored; and
the first shared node sending a SHARED LINK UP message to notify the second master node that the first shared link is restored,
wherein the second master node determines that the first shared link is restored when the second master node receives the SHARED LINK UP message.

8. The method of claim 6, wherein the first shared node has an extension port that connects to the second Ethernet ring, and wherein
the ring-recovery process further comprises:
the first shared node receiving a SHARED LINK HELLO message from the first shared link and determining that the first shared link is restored;
the first shared node sending a SHARED LINK UP message to notify the second master node that the first shared link is restored and blocking the extension port from sending data to or receiving data from the second Ethernet ring;
the second master node sending a COMPLETE-FLUSH FDB message upon receiving the SHARED LINK UP message; and
the first shared node unblocking the extension port upon receiving the COMPLETE-FLUSH FDB message.

9. The method of claim 6, wherein the second master node has a primary port and a secondary port that is blocked from receiving data, and the first shared node has an extension port that connects to the second Ethernet ring, and wherein
the ring-extension process further comprises:
the second master node unblocking the secondary port to allow data to be received at the secondary port, and wherein
the ring-recovery process further comprises:
the first shared node receiving a SHARED LINK HELLO message from the first shared link and determining that the first shared link is restored;
the first shared node sending a SHARED LINK UP message to notify the second master node that the first shared link is restored and blocking the extension port from sending data to or receiving data from the second Ethernet ring;
the second master node blocking the secondary port upon receiving the SHARED LINK UP message and sending a COMPLETE-FLUSH FDB message;
the first shared port unblocking the extension port upon receiving the COMPLETE-FLUSH FDB message; and
the second transit node leaving the first Ethernet ring upon receiving the COMPLETE-FLUSH FDB message.

10. The method of claim 1, wherein each of the plurality of Ethernet rings has a respective master node and at least one transit node, and each Ethernet ring intersects a neighbouring Ethernet ring at a respective shared link connecting at least two shared nodes shared between the two intersecting Ethernet rings, and wherein each Ethernet ring is identified by a ring sequence number, the first Ethernet ring being identified by a first ring sequence number that is the lowest ring sequence number amongst the plurality of Ethernet rings, and the second Ethernet ring being identified by a second ring sequence number that is higher than the first ring sequence number, the method further comprising:
a set-up process including:
recording first correspondence information between the ports of the first master node and the first transit node, and the first ring sequence number; and
recording second correspondence information between the ports of the second master node and the second transit node, and the second ring sequence number, and between the ports of the second master node and the second transit node, and the ring sequence number of each Ethernet ring amongst the plurality of Ethernet rings having a ring sequence number lower than the second ring sequence number.

11. The method of claim 10, wherein
in the ring-extension process:
the second master node and the second transit node join the first Ethernet ring in accordance with the first and second correspondence information.

12. A fault handling method for a communication network comprising a plurality of Ethernet rings, each Ethernet ring intersecting one or more neighbouring Ethernet rings at a respective shared link connecting at least two shared nodes, each of the plurality of Ethernet rings including a respective master node and one or more transit nodes, and each Ethernet ring being identified by a ring sequence number, the method comprising:
a shared node of a shared link notifying a master node in a first notification of a fault detected at said shared link, said master node belonging to an Ethernet ring identified by the highest ring sequence number amongst a plurality of intersecting Ethernet rings sharing said shared link;
said master node joining, upon receiving said first notification, each of said plurality of intersecting Ethernet rings at said shared link as a transit node of said plurality of intersecting Ethernet rings;
said master node notifying, in a second notification, the one or more transit nodes of said Ethernet ring identified by the highest sequence number to join said plurality of intersecting Ethernet rings; and
said one or more transit nodes joining said plurality of intersecting Ethernet rings upon receiving said second notification.

13. A communication device for implementation in an Ethernet ring, said Ethernet ring being one of a plurality of intersecting Ethernet rings in a communication network, the device including a primary port and a secondary port that is blocked from receiving data, the device comprising:
a ring-extension module configured to: determine a fault in a shared link at which said Ethernet ring intersects a neighbouring Ethernet ring, unblock said secondary port to allow data to be received, configure the device to join said neighbouring Ethernet ring, and send a first notification in said Ethernet ring; and
a ring-recovery module configured to: determine said shared link is restored, block said secondary port from receiving data, configure the device to leave said neighbouring Ethernet ring, and send a second notification in said Ethernet ring.

14. A communication device for implementation in an Ethernet ring, said Ethernet ring being one of a plurality of intersecting Ethernet rings in a communication network, the device comprising:
a ring-extension module configured to: receive a first notification from said Ethernet ring, said first notification containing information of a neighbouring Ethernet ring intersecting said Ethernet ring at a shared link, and configure the device to join said neighbouring Ethernet ring in accordance with said first notification; and
a ring-recovery module configured to: receive a second notification from said Ethernet ring, said second notification containing information of said neighbouring Ethernet ring, and configure the device to leave said neighbouring Ethernet ring in accordance with said second notification.

15. The communication device of claim 13 wherein the device is provided at said shared link, and includes an extension port that connects to said Ethernet ring, and wherein
said ring-extension module is further configured to send a third notification in said Ethernet ring in response to a detection of a fault in said shared link; and
said ring-recovery module is further configured to send a fourth notification in said Ethernet ring in response to a detection that said shared link is restored, and to block said extension port from sending/receiving data until a COMPLETE-FLUSH FDB message is received, whereupon said extension port is unblocked.

16. The communication device of claim 13 wherein each Ethernet ring is identified by a ring sequence number, said neighbouring Ethernet ring being identified by a lower ring sequence number than said Ethernet ring, and wherein said first notification and said second notification each contains the ring sequence number of said Ethernet ring and the ring sequence number of said neighbouring Ethernet ring.
